(19) United States
(12) Patent Application Publication
(10) Pub. No.: US 2022/0041319 A1
(43) Pub. Date: Feb. 10, 2022

(54) CONTAINERS COMPRISING CELLULOSE HYDRATE AND METHODS OF MANUFACTURE

(71) Applicant: HOPE TREE INTERNATIONAL GMBH, HOLZKIRCHEN (DE)

(72) Inventor: LAMBERT DUSTIN DINZINGER, GERETSRIED-GELTING (DE)

(21) Appl. No.: 17/413,614

(22) PCT Filed: Dec. 16, 2019
(86) PCT No.: PCT/EP2019/085435

§ 371 Date: Jun. 14, 2021

(30) Foreign Application Priority Data
Dec. 14, 2018 (DE) 10 2018 221 810.2
Jan. 15, 2019 (DE) 10 2019 200 385.0

(51) Int. Cl. B65D 3/22; A47G 19/03; B31B 50/74; B31B 50/83; B31B 50/88; B65D 3/06; B65D 65/46; B65D 65/42; B65D 3/28; B65D 25/54; B32B 1/02; B32B 7/12; B32B 23/14; B32B 23/06

(52) U.S. Cl. CPC B65D 3/22; B31B 2105/0022; B31B 50/747; B31B 50/83; B31B 50/88; B65D 3/06; B65D 65/466; B65D 65/42; B65D 3/28; B65D 25/54; B32B 1/02; B32B 7/12; B32B 23/14; B32B 23/06; A47G 19/03

(57) ABSTRACT

The invention relates to the field of cups, bowls and containers, particularly beverage cups, and to the production of cups, bowls and containers. According to the invention, the cups, bowls and containers comprise, in a first variant, a first layer (5) made of cellulose hydrate, also known as cellophane, or cellulose hydrate which is coated with a primer material (4). In addition, the cups, bowls and containers can comprise a second layer (3), made of paperboard or fibre/cellulose-starch mix, for example. In a second variant, the cups, bowls and containers according to the invention comprise a first layer made of natural rubber or plant-based wax and a second layer made of cellulose hydrate, paperboard or fibre/cellulose-starch mix. By using exclusively biodegradable materials, the present invention can provide completely biodegradable/compostable cups, bowls and containers. The invention also relates to a method for producing such cups, bowls and containers. In addition, the present invention also comprises the production of lids made of the aforementioned materials and the provision of cups, bowls and containers having such lids.

### CROSS-REFERENCE TO RELATED APPLICATIONS

This application is a national phase entry under 35 U.S.C. § 371 of International Patent Application PCT/EP2019/085435, filed Dec. 16, 2019, published as International Patent Publication WO 2020/120803 on Jun. 18, 2020, which claims the benefit of German Patent Application DE 10 2018 221 810.2, filed on Dec. 14, 2018, and German Patent Application DE 10 2019 200 385.0, filed on Jan. 15, 2019, the contents of all are hereby incorporated by reference.

### TECHNICAL FIELD OF THE INVENTION

The present invention is in the field of cups, trays and containers, preferably beverage cups, and the manufacture of such cups, trays and containers, hereinafter generally referred to as cups. Using cellulose hydrate, also known as cellophane, or cellulose hydrate and a paperboard or fiber/pulp starch mix, in combination with a primer, biodegradable cups can be produced in transparent, semi-transparent or opaque embodiments. Similarly, using natural rubber or plant-based waxes and a mix of cellulose hydrate, paperboard, fiber/pulp and/or starch, biodegradable cups can be produced in transparent, semi-transparent or opaque embodiments. Colored cups can also be produced by adding food coloring. The present invention also uses the same materials to make lids for cups.

### BACKGROUND OF THE INVENTION

In Germany alone, several hundred thousands of beverage cups are consumed every hour. After an average of just 15 minutes of use, these cups end up carelessly discarded in public places, on the street, in nature or in the sea. Since common disposable beverage cups are neither recyclable nor compostable, they can only be incinerated or recycled at enormous cost and energy, thus harming the preservation of our ecosystem.

Nevertheless, disposable beverage cups enjoy great popularity worldwide because they are easy to use, practical and hygienic. As a result, the need for an environmentally friendly, recyclable and compostable alternative to conventional beverage cups is enormous.

### SUMMARY OF THE INVENTION

Such an alternative is provided by the cups, trays and containers, in particular beverage cups of the present invention, and the methods of making the same. As stated above, the invention relates to trays, cups and containers, preferably beverage cups, which are hereinafter generally referred to as cups.

While conventional cups are made of plastic or else paper coated with plastic or wax, cups of the present invention are made of purely plant-based materials, such as cellulose hydrate and cardboard or fiber/cellulose starch mix, as well as non-vulcanized natural rubber or plant-based wax and a mix of cellulose hydrate, cardboard, fiber/cellulose and/or starch. The cups are thus not only easy to recycle or compost, they are also produced from renewable raw materials that have a positive carbon footprint. Due to the plant-based starch content, the cups can even be used as plant fertilizer or serve as fish food should they ever end up in the sea. Therefore, the cups of the present invention form a very good, environmentally friendly and environmentally conscious alternative to common disposable beverage cups.

Another advantage of the present invention is that fully transparent cups can also be made from cellulose hydrate.

Cup—Variant 1

The present invention relates to a cup comprising a bottom (1) and a side wall (2), wherein the side wall (2) comprises a first layer (5), wherein the first layer (5) is made of cellulose hydrate, wherein the first layer is coated with a primer material (4).

In some embodiments, the primer material (4) comprises plant material and water, preferably plant derived starch and water. In some of these embodiments, the primer material (4) comprises gum arabic, and/or potato starch, cornstarch, or tapioca starch; or starch from cassava, tuberous bean, batata, yam, tuberous pea, arakacha, bulbous wood sorrel, bulbous nasturtium, ulluco, East Indian arrowroot, arrowroot, achira, taro, tannia, white water lily, yellow pond rose, or chayote. In preferred embodiments, the primer material (4) comprises gum arabic and starch, preferably potato starch or cornstarch. In particularly preferred embodiments, the primer material additionally comprises water.

In some embodiments, the sidewall (2) of the cup further comprises a second layer (3), wherein the second layer (3) comprises cellulose hydrate, paper, cardboard, pulp, fiber, starch, or a mixture thereof, wherein the first layer (5) and the second layer (3) are joined by the primer material (4). In some embodiments, the second layer (3) comprises cellulose hydrate, paper, paperboard, pulp, fiber, starch, or a mixture thereof. In one embodiment, the second layer (3) comprises cellulose pulp and/or fiber pulp and further comprises magnesium stearate. In preferred embodiments, the second layer (3) is at least partially made of baobab plant material. In particularly preferred embodiments, the second material comprises baobab plant material and the primer material comprises gum arabic and starch, wherein the starch is preferably potato starch or cornstarch.

In some embodiments, the base (1) comprises cellulose hydrate. In preferred embodiments, the bottom (1) of the cup comprises the same material as the side wall (2) of the cup.

In some embodiments, the cup comprises at least one viewing window (6) or is completely transparent.

In some embodiments, where the sidewall (2) of the cup comprises a first layer (5) and a second layer (3), the first layer (5) is the inner layer of the cup and the second layer (3) is the outer layer of the cup.

The cups of the present invention are recyclable, preferably compostable and/or fully biodegradable.

Cup—Variant 2

As an alternative to the previously described cups with at least one cellulose hydrate layer and applied primer material, the present invention also provides cups comprising a bottom (1) and a sidewall (2), wherein the sidewall (2) comprises a first layer (5) and a second layer (3), wherein the first layer (5) consists of natural rubber or plant-based wax, and the second layer (3) comprises cellulose hydrate, paper, cardboard, pulp, fibrous material, starch or a mixture thereof.

In one embodiment, the first layer (5) comprises plant-based wax comprising canola wax and/or sunflower wax and/or soy wax and/or carnauba wax, preferably carnauba wax. In some embodiments, the first layer (5) comprises plant-based wax, preferably carnauba wax.

In one embodiment, the second layer (3) comprises pulp and/or fiber and/or starch. In one embodiment, the second layer comprises starch and magnesium stearate. In preferred embodiments, the second layer (3) is at least partially made of baobab plant material. In preferred embodiments, the second layer comprises wheat starch, cellulose, and magnesium stearate. In preferred embodiments, the second layer comprises 70-95% starch and 5-30% cellulose. In particularly preferred embodiments, the second layer comprises 89% starch, preferably wheat starch, 10% pulp, and 1% magnesium stearate, although optionally 89% starch may be replaced with 84% starch, preferably wheat starch, and 5% wheat flour.

In some embodiments, the second layer (3) comprises cellulose hydrate, paper, paperboard, pulp, fiber, starch, or a mixture thereof. In some embodiments, the second layer (3) comprises cellulose pulp and/or fiber pulp and/or starch and further comprises magnesium stearate. In other embodiments, the second layer (3) comprises wheat starch, pulp and magnesium stearate and optionally wheat flour.

In the cups of this alternative, the bottom (1) is preferably made of the same material as the sidewall (2). In this case, the bottom and sidewall are preferably made of one piece.

In some embodiments, where the side wall (2) of the cup comprises a first layer (5) and a second layer (3), the first layer (5) is the inner layer of the cup and the second layer (3) is the outer layer of the cup.

The cups of the present invention are recyclable, preferably compostable and/or fully biodegradable. In some embodiments, the cups are compostable and/or fully biodegradable within 40 days, preferably within 28 days. In addition, they can be used as garden fertilizer due to their starch content.

Manufacturing Process for Cup Variant 1

In addition, the present invention provides methods for manufacturing cups having at least one cellulose hydrate layer and applied primer material.

In one embodiment, this is a method of manufacturing a cup comprising a bottom (1) and a side wall (2) and a bottom, the method comprising the following steps:
a. providing a first material for a first layer (5) of the side wall (2) of the cup, wherein the first material is cellulose hydrate,
b. coating the first material with a primer material (4),
c. cutting the first material coated with the primer material to size,
d. shaping the cut first material to form the side wall (2) of the cup, and joining a bottom (1) to the side wall (2) of the cup.

In a second embodiment, this is a method of manufacturing a cup comprising a bottom (1) and a side wall (2) and a bottom, the method comprising the following steps:
a. providing a second material for a second layer (3) of the side wall (2) of the cup, wherein the second material comprises cellulose hydrate, paper, cardboard, pulp, fiber, starch or a mixture thereof,
b. coating the second material with a primer material (4),
c. providing a first material for a first layer (5) of the side wall (2) of the cup, wherein the first material is cellulose hydrate,
d. bonding the first and second materials, at least partially by means of the primer material (4),
e. cutting the joined first and second materials to size,
f. shaping the cut first and second materials to form the side wall (2) of the cup, and joining a bottom (1) to the side wall (2) of the cup.

In a third embodiment, this is a method of manufacturing a cup comprising a bottom (1) and a side wall (2) and a bottom, the method comprising the following steps:
a. providing a second material for a second layer (3) of the side wall (2) of the cup and the bottom (1) of the cup, wherein the second material comprises cellulose hydrate, paper, paperboard, pulp, fiber, starch, or a mixture thereof,
b. forming the second material to give it the shape of a cup comprising side wall and bottom,
c. coating the second material with a primer material (4),
d. providing a first material for a first layer of the side wall (2) of the cup and the bottom (1) of the cup, wherein the first material is cellulose hydrate,
e. shaping the first material to give it the shape of a cup comprising a side wall and a bottom,
f. bonding the first and second materials, at least partially by means of the primer material (4).

In all embodiments of the method, the primer material (4) may be gum arabic, and/or potato starch, corn starch or tapioca starch; or starch from cassava, tuberous bean, batata, yam, tuberous pea, arakacha, bulbous wood sorrel, bulbous nasturtium, ulluco, East Indian arrowroot, arrowroot, achira, taro, tannia, white water lily, yellow pond rose, or chayote. In preferred embodiments, the primer material (4) comprises gum arabic and starch, preferably potato starch or cornstarch. In particularly preferred embodiments, the primer material additionally comprises water.

When the cup comprises a second material, in some embodiments the second material comprises baobab plant material. In particularly preferred embodiments, the second material comprises baobab plant material and the primer material comprises gum arabic and starch, wherein the starch is preferably potato starch or corn starch

In some embodiments, the method further comprises punching a viewing window (6) in the second material and/or printing the first material and/or the second material.

Manufacturing Process Cup Variant 2

Furthermore, the invention provides methods for the production of cups that are an alternative to those with at least one cellulose hydrate layer and applied primer material.

The method of the invention is method for manufacturing a cup comprising a bottom (1) and a side wall (2) and a bottom, wherein the method comprises the following steps:
a. providing a second material for a second layer (3) of the side wall (2) of the cup and the bottom (1) of the cup,
b. wherein the second material comprises cellulose hydrate, paper, paperboard, pulp, fiber, starch, or a mixture thereof,
c. forming the second material to give it the shape of a cup comprising side wall and bottom,
d. curing the second material,
e. providing a first material for a first layer of the side wall (2) of the cup and the bottom (1) of the cup, wherein the first material comprises natural rubber or plant-based wax, preferably carnauba wax,
f. coating the second layer (3) of the sidewall (2) of the cup and the bottom (1) of the cup of the second material with the first material, thereby producing the first layer (5) of the sidewall (2) of the cup and the bottom (1) of the cup.

In some embodiments, the first material is natural rubber or plant-based wax comprising canola wax and/or sunflower wax and/or soy wax and/or carnauba wax, preferably carnauba wax.

In some embodiments, the second material may comprise cellulose and/or fiber pulp and/or starch, and may further comprise magnesium stearate. In preferred embodiments, the second material comprises at least in part baobab plant material. In even more preferred embodiments, the second material comprises wheat starch, pulp, and magnesium stearate. Additionally, the second material may comprise water. In an even more preferred embodiment, the second material comprises 70-95% starch and 5-30% cellulose and additionally water. In the most preferred embodiment, the second material comprises 89% starch, preferably wheat starch, 10% pulp and 1% magnesium stearate, and additionally 70% water (corresponding to a total mixture of 52.4% starch, 41.1% water, 5.9% pulp and 0, 6% magnesium stearate) or 84% starch, preferably wheat starch, 10% pulp, 5% wheat flour, and 1% magnesium stearate and an additional 70% water (equivalent to a total blend of 49.5% starch, 41.1% water, 5.9% pulp, 2.9% wheat flour, and 0.6% magnesium stearate).

In some embodiments, the second material additionally comprises food coloring.

In some embodiments, the method further comprises printing the first material and/or the second material.

Lids for Cups, Bowls and Containers

In addition to cups, trays and containers, preferably beverage cups, the present invention also provides lids for these cups, trays and containers, hereinafter generally referred to as cups. A lid of the present invention comprises the material described above for the side wall of the cup.

Thus, the lid of the present invention comprises a first layer comprising cellulose hydrate, the first layer being coated with a primer material (cup variant 1). Alternatively, the lid of the present invention comprises a first layer comprising natural rubber or plant-based wax and a second layer comprising paper, paperboard, pulp, fiber, starch, or a mixture thereof (cup variant 2). In some embodiments, the lid of the present invention further comprises magnesium stearate.

In preferred embodiments, the lid is compostable and/or fully biodegradable.

The present invention also comprises a combination cup and lid formed from a cup of the present invention and a lid of the present invention. Preferably, in this case, the side wall of the cup and the lid are made of the same material.

Finally, the invention also provides a method of manufacturing a cup and lid combination formed from a cup of the present invention and a lid of the present invention. The cup is manufactured according to a method described above. In some embodiments, the lid is made by the same process as the cup. In preferred embodiments, the cup and lid are manufactured by a compression molding process or casting process. In particularly preferred embodiments, the cup and lid are made by a compression molding or casting process and comprise magnesium stearate.

### Advantages of the Invention

The present invention provides cups comprising a layer of cellulose hydrate coated with a primer material. The cellulose hydrate serves as a barrier coating (primarily a water barrier) in the cups of the present invention. This property, as well as the stability of the cups, is enhanced by the primer material. The same functions are performed by cellulose hydrate and primer material for the lids of the present invention.

By using cellulose hydrate and a biodegradable primer material, the cups and lids of the present invention are functional and versatile, but unlike conventional disposable cups, they are fully biodegradable or even compostable. In addition, the cups of the present invention can be partially or fully transparent.

The present invention also provides cups that include a layer of natural rubber or plant-based wax. This layer serves as a barrier coating (especially a water barrier) in the cups of the present invention. This property, as well as the stability of the cups, is enhanced by the natural rubber or wax. The same functions are performed by natural rubber or wax for the lids of the present invention. Also, a layer of natural rubber or wax increases the surface texture of the cup (the second layer) and/or lid and the cups and lids thus adhere better to each other.

By using non-vulcanized natural rubber or wax and a mix of cellulose hydrate, cardboard, fiber/pulp and/or starch, the cups and lids of the present invention are functional and versatile, but unlike conventional disposable cups, are fully biodegradable or even compostable. If the cups contain plant-based starch, they can even be used as plant fertilizer or serve as fish food should they ever end up in the ocean.

In addition, the cups of the present invention can be partially or completely transparent or colored by means of food coloring. Colored cups and/or lids can thus contribute to the recognition value of certain companies and/or contents.

If the second layer of the cup and/or lid comprises magnesium stearate, this has the advantage that the cast second layer can be more easily released from a mold. Therefore, a second layer comprising magnesium stearate is particularly suitable when a compression molding or casting process, such as injection molding or hot pressing, is used.

### BRIEF DESCRIPTION OF THE DRAWINGS

FIG. 1: This figure shows a cup according to the present invention. The cup includes a bottom (1) and a side wall (2). To illustrate the layers, the sidewall (2) is shown open on the right and separated into layers. The sidewall includes an inner first layer (5) of cellulose hydrate and an outer second layer (3) of paper, paperboard, fiber/pulp, starch, or cellulose hydrate. A primer material (4, indicated by the hatching) is applied between the layers.

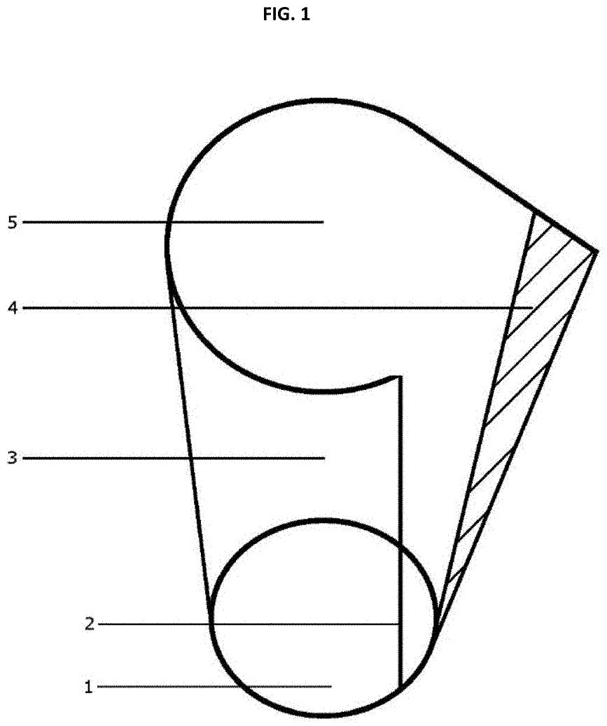

FIG. 2: This figure shows a cup according to the present invention. The cup includes a viewing window (6) in the side wall (2).

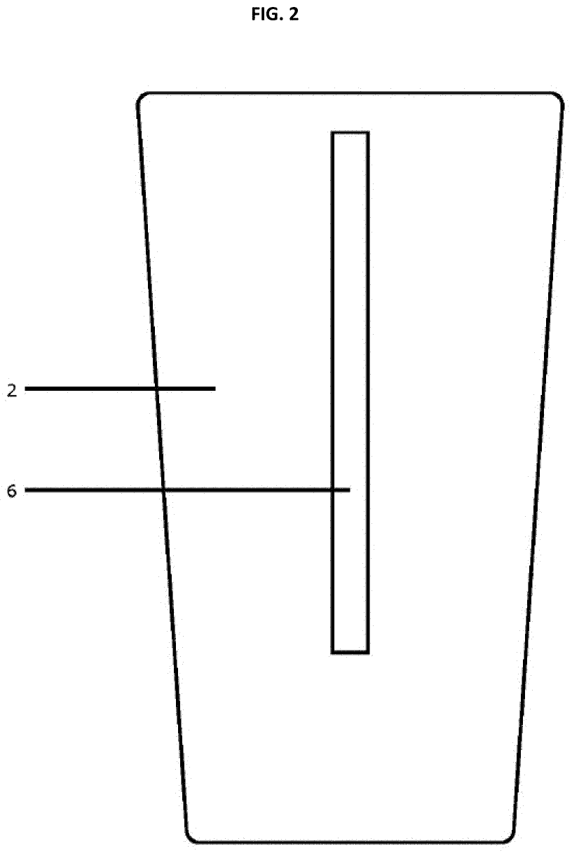

FIG. 3: This figure shows cups and lids (Variant 2) according to the present invention, being beverage cups with corresponding lids of the present invention. The figure shows cups of various sizes, both with and without lids.

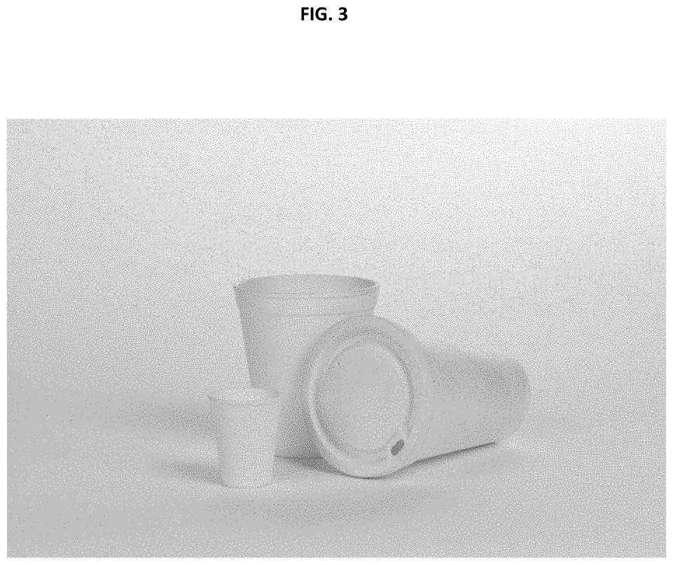

FIG. 4: This figure shows cups and lids (Variant 2) according to the present invention. The figure shows cups of various sizes, both with and without lids.

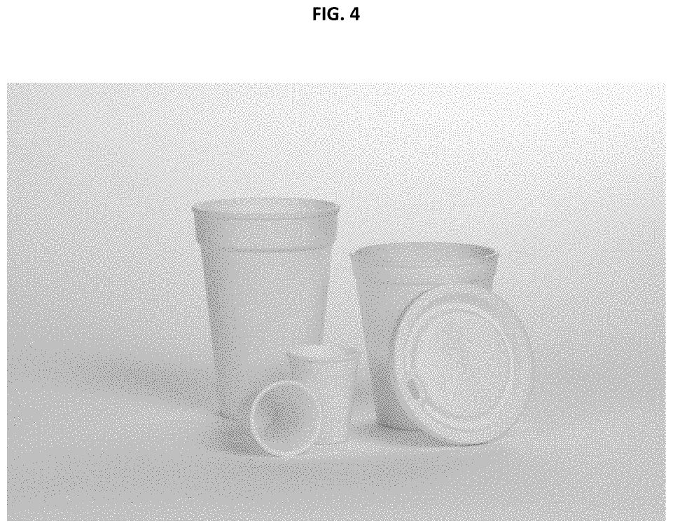

FIG. 5: This figure shows a cup and lid (Variant 2) according to the present invention, being a container with a corresponding lid of the present invention, used for example as a storage or soup container.

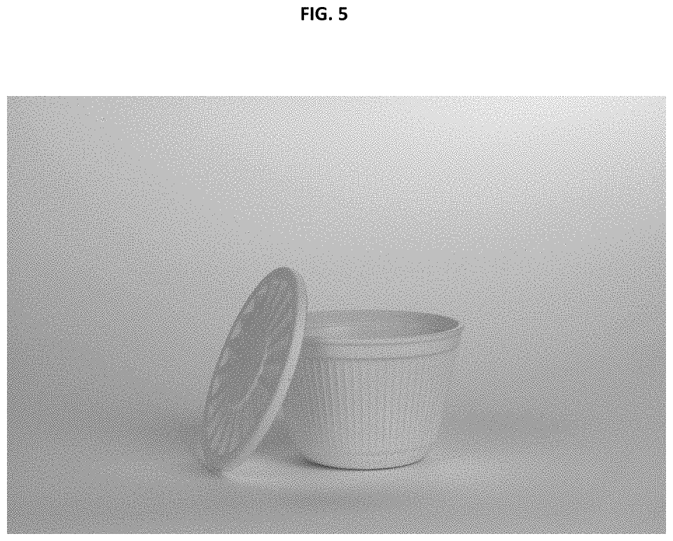

### DETAILED DESCRIPTION OF THE INVENTION

### Definitions

Cellulose hydrate, often also referred to by the trade name Cellophane or as cellophane, is a synthetic material of natural origin produced from cellulose. Cellulose xanthate is obtained by reacting cellulose with sodium hydroxide solution (NaOH) and carbon disulfide (CS2). The solution of xanthogenate in sodium hydroxide solution is honey-yellow and viscous (viscose). It is forced through slot nozzles into acid precipitation baths. Carbon disulfide and hydrogen sulfide (H2S) are released during this process. The resulting cellulose hydrate films are passed through washing baths and dried.

The term “primer” or “primer material” refers to an adhesion promoter that can bond two immiscible materials. On the one hand, the application of primer material serves to bring two materials together; on the other hand, it also gives a material coated with it increased stability. For example, a primer material can act as an adhesive to bond paperboard to cellulose hydrate and/or which increases the stability of cellulose hydrate. Preferred primers of the present invention are vegan, fully biodegradable, compostable, acid-free, and/or crystal clear. A particularly preferred primer of the present invention meets all of these characteristics. Preferably, the primer material is heat reactive. Suitable primers of the present invention comprise plant material, preferably starch derived from plants. A preferred primer of the present invention comprises gum arabic and starch. In addition, the primer preferably comprises a liquid component, such as water. Therefore, an exemplary primer of the present invention comprises gum arabic, starch and water. The starch here is preferably potato starch or cornstarch. The proportion of gum arabic may be 1-50%, preferably 5-20%, more preferably 10%. The starch content may be 5-70%, preferably 15-50%, more preferably 30%. The water content may be 10-90%, preferably 30-80%, more preferably 60%. A particularly preferred primer of the present invention contains 10% gum arabic, 30% starch (potato starch or cornstarch) and 60% water. Table 1 shows the composition of exemplary primer materials of the present invention.

TABLE 1
Exemplary compositions of the primer material

| Exemplary | | Starch (e.g. from | |
|---|---|---|---|
| primer material | Gummi arabicum | potato or corn) | Water |
| 1 | 5-20% | 15-50% | 30-80% |
| 2 | 10-15% | 20-40% | 45-70% |
| 3 | 5% | 15-50% | 45-80% |
| 4 | 10% | 15-50% | 40-75% |
| 5 | 5-20% | 50% | 30-45% |
| 6 | 5-20% | 30% | 50-65% |
| 7 | 5% | 50% | 45% |
| 8 | 10% | 50% | 40% |
| 9 | 5% | 30% | 65% |
| 10 | 10% | 30% | 60% |

“Plant-based starch” refers to any starch obtained from plant material. The starch may be obtained from roots, beets, tubers, rhizomes, shoot axes, leaves, fruits or seeds, for example. Examples of plant starch include wheat starch, potato starch, corn starch, or tapioca starch; starch from cassava (Manihot esculenta), tuber bean (Pachyrhizus tuberosus), batata (Ipomoea batatas), yam (Dioscorea spec.), tuberous pea (Lathyrus tuberosus), arakacha (Arracacia xanthorrhiza), tuberous wood sorrel (Oxalis tuberosa), tuberous nasturtium (Tropaeolum tuberosum), ulluco (Ullucus tuberosus), East Indian arrowroot (Tacca leontopetaloides), arrowroot (Maranta spec.), Achira (Canna indica), Taro (Colocasia esculenta), Tannia (Xanthosoma sagittifolium), White Water Lily (Nymphaea alba), Yellow Pond Rose (Nuphar lutea) or Chayote (Sechium edule). When starch is not used as a component of a primer in the present invention, wheat starch, potato starch and cornstarch are preferred. The use of wheat starch is particularly preferred.

“Paperboard” and “paper” as used herein describes the same chemical material, “paperboard” being used when the weight per square meter is greater than 225 g/m2 and “paper” being used when the weight per square meter is less than 225 g/m2.

“Fiber pulp” means fiber-derived material used in the manufacture of paper and paperboard. Fiber materials consist largely of cellulose. Fiber materials include pulp and wood pulp.

“Pulp” refers to the fibrous mass produced during the chemical pulping of plants, primarily wood. It consists to a large extent of cellulose.

“Mechanical pulp” refers to the fibrous mass produced during mechanical pulping of plants, primarily wood. Wood pulp, unlike the pulp used for higher quality papers, contains large amounts of lignin.

“Wax” means any naturally occurring wax, such as carnauba wax, rapeseed wax, sunflower wax or soy wax. In the present invention, carnauba wax is preferred.

“Carnauba wax” is obtained from the leaf of the carnauba palm (Copernicia prunifera). In the present invention, carnauba wax is preferably used in powder form. Carnauba wax represents a particularly preferred embodiment of the invention.

“Soy wax” is obtained from ripe soybeans (Glycine max). In the present invention, soy wax is preferably used in flake form. Soy wax represents a particularly preferred embodiment of the invention.

“Rapeseed wax” or “canola wax” herein is obtained from rapeseed oil and this in turn is obtained from ripe rapeseed. Rapeseed wax represents an embodiment form of the invention.

“Sunflower wax” is obtained from sunflower oil and this in turn is obtained from sunflower seeds. Sunflower wax represents one embodiment of the invention.

“Natural rubber” is a rubbery substance contained in the milky sap of rubber plants (e.g., rubber tree (Hevea brasiliensis). Natural rubber can be isolated from this milky sap, known as latex. Purified natural rubber is approximately transparent, with a slight yellow tint. At temperatures of 3° C. or lower, the rubber becomes brittle. At temperatures above 145° C. it starts to become sticky. At temperatures above 170° C., it becomes liquid.

“Magnesium stearate” is the magnesium salt of stearic acid. It is obtained from fats and oils. Soybean, canola or corn oil is often used. Magnesium stearate is preferably used in concentrations between 0.25% and 5.0%.

“Food color” refers to colorants used in the food industry, especially natural colorants derived from plants or animals. Preference is given to plant-based colorants, such as natural extracts and concentrates from plants, fruits or vegetables. An example of such a dye is spirulina blue (phycocyanin). It is the only natural blue colorant for food and is extracted from the Spirulina algae (Spirulina platensis). Other examples include carotenoids, berry dyes (anthocyanins), beet dyes (betanin) and dyes from spices such as paprika, saffron and turmeric (curcumin), or extracts from plants or fruits such as beet, spinach or elderberry juice.

“Compostable” refers to the property of a material to be 90% degraded after 6 months under defined aerobic conditions. The compostability of a material can be determined according to DIN EN 13432, version 2000-12.

“Biodegradable” refers to the characteristic of a process to completely degrade an organic substance biologically, i.e. by living organisms or their enzymes. In this process, the degradation of the substance takes place under aerobic conditions in 10 years or less, preferably in 5 years, even more preferably in 1 year.

“Recyclable” means that after the material has been used (for example, as a cup), it can be reprocessed (recycled) as a material to make a new product that is not intended for incineration. This is in contrast to materials that, after use, must either be recovered through incineration or permanently landfilled. Recyclable materials include paper, cardboard and cellulose hydrate. Paper coated with wax, for example, is not recyclable.

### Embodiments of the Invention

Cup

A cup of the present invention includes a bottom and a side wall. In particularly preferred embodiments, the cup is biodegradable and/or even compostable. In some embodiments, the cup is partially or completely transparent or colored with food coloring.

Cup Variant 1

a) Bottom

The bottom of the cup is impermeable to water. Preferably, it is recyclable, biodegradable and/or compostable.

In preferred embodiments, the bottom of the cup comprises at least a first layer of cellulose hydrate. In even more preferred embodiments, the first layer of cellulose hydrate is coated with a primer material. Further, the bottom of the cup may comprise a second layer. In this case, the innermost layer of the cup preferably comprises cellulose hydrate. The second layer may comprise or consist of cellulose hydrate, paper, paperboard, pulp, fiber, starch, or a mixture thereof. In one embodiment, the base comprises magnesium stearate. Magnesium stearate acts as a lubricant and causes the cast object (in this case, the second layer of the base) to release from the mold more easily. This is favorable for casting processes, especially injection molding and hot pressing. The second layer preferably contains 1-20%, more preferably 2-10%, and most preferably 3-8% magnesium stearate. An exemplary suitable second layer of the base comprises 8% fiber, 86.5% potato starch, 5% magnesium stearate and 0.5% preservatives.

In particularly preferred embodiments, the second layer of the soil is at least partially made from baobab plant material.

In embodiments having multiple layers, the primer material binds the first layer and the second layer.

Exemplary bottoms of the cups of the present invention comprise a first cellulose hydrate layer coated with a primer material; a first cellulose hydrate layer coated with a primer material; and a second cellulose hydrate layer; of a first cellulose hydrate layer coated with a primer material and a second layer of paperboard or paper; of a first cellulose hydrate layer coated with a primer material; and a second layer of pulp and starch; or of a first cellulose hydrate layer coated with a primer material and a second layer of pulp. In particularly preferred embodiments, the bottom of the cup is made of the same material as the sidewall of the cup.

In some embodiments, the bottom is manufactured separately from and subsequently bonded to the sidewall of the cup. In other embodiments, the base and sidewall, or one or more layers of the base and sidewall, are manufactured in one piece. This is the case, for example, when at least one layer of the base and sidewall are produced by a compression molding process or casting process (e.g., hot compression molding process or injection molding process).

In some embodiments, the bottom of the cup is transparent. This is the case, for example, when it consists of only one or more layers of cellulose hydrate.

b) Side Wall

The side wall of the cup is impermeable to water. It is biodegradable and/or even compostable.

The sidewall of the cup comprises at least a first layer comprising cellulose hydrate coated with a primer material. The first layer may have a thickness between 0.01 mm and 10 mm, between 0.02 mm and 7 mm, or between 0.05 mm and 5 mm. For cups without a second layer or with a second layer of cellulose hydrate, the thickness of the first layer is preferably between 0.5 mm and 1.5 mm, more preferably between 0.8 mm and 1.2 mm. Exemplary thicknesses of the first layer here are 1 mm and 1.2 mm. For cups having a second layer comprising paper, paperboard, pulp, fiber, starch or a blend, the thickness of the second layer is preferably between 0.01 mm and 0.5 mm, more preferably between 0.02 mm and 0.1 mm. An exemplary thickness of the first layer here is 0.023 mm.

In addition, the side wall of the cup may comprise a second layer. In this case, the innermost layer of the cup is preferably cellulose hydrate (i.e., the first layer is preferably the inner layer, and the second layer is preferably the outer layer). The second layer may comprise or consist of cellulose hydrate, paper, paperboard, pulp, fiber, starch, or a mixture thereof. In some embodiments, the second layer comprises paperboard or paper. In this regard, the thickness may be 100-350 g/m2, preferably 170-350 g/m2, more preferably 150 g/m2. Preferably, the paperboard or paper has high stiffness and good wet sizing. The latter reduces the internal surface tension and thus capillarity, and significantly increases the tear strength of the paper/board by sealing the fiber-to-fiber bonding sites. Likewise, the paper/board preferably exhibits good elongation properties.

In other embodiments, the second layer comprises 1-50% (preferably 5-20%, more preferably 8%) pulp, 50-97% (more preferably 70-95%, even more preferably 91.5%) starch, and 0-1% (more preferably 0.5%) preservatives. The ratio of fibers (pulp) to starch is preferably between 1:20 and 2:3.

In another embodiment, the second layer comprises magnesium stearate. Magnesium stearate acts as a lubricant and causes the cast object (in this case the second layer) to release from the mold more easily. This is favorable for casting processes, especially for injection molding and hot pressing processes. The second layer preferably contains 1-20%, more preferably 2-10%, and most preferably 3-8% magnesium stearate. An exemplary suitable second layer comprises 8% fiber, 86.5% potato starch, 5% magnesium stearate and 0.5% preservatives.

In particularly preferred embodiments, the second layer is at least partially made from baobab plant material. Preferably, the second layer has a thickness between 0.1 mm and 5 mm, more preferably between 0.15 mm and 2 mm, even more preferably between 0.2 mm and 1 mm. Exemplary thicknesses of the second layer are 0.2 mm and 0.35 mm.

In embodiments having multiple layers, the primer material bonds the first layer and the adjacent second layer.

Exemplary sidewalls of the cups of the present invention comprise a first cellulose hydrate layer coated with a primer material; a first cellulose hydrate layer coated with a primer material; and a second cellulose hydrate layer; of a first cellulose hydrate layer coated with a primer material and a second layer of paperboard or paper; of a first cellulose hydrate layer coated with a primer material; and a second layer of pulp and starch; or of a first cellulose hydrate layer coated with a primer material and a second layer of pulp. In particularly preferred embodiments, the sidewall of the cup is made of the same material as the bottom of the cup.

In some embodiments, the sidewall is manufactured separately from the bottom of the cup and subsequently bonded thereto. In other embodiments, the base and sidewall, or one or more layers of the base and sidewall, are manufactured in one piece. This is the case, for example, when at least one layer of the base and sidewall are produced by a compression molding process or casting process (e.g., hot compression molding process or injection molding process).

In some embodiments, the side wall of the cup comprises one or more viewing windows. These may be produced, for example, by cutting a window into a second non-transparent layer, such as paperboard, so that the cup comprises only the first layer of cellulose hydrate at the position of the window.

In other embodiments, the side wall of the cup is completely transparent. This is the case, for example, when it consists of only one or more layers of cellulose hydrate.

Properties of the Cups

The present invention provides cups comprising a layer of cellulose hydrate coated with a primer material. The cellulose hydrate serves as a barrier coating (primarily a water barrier) in the cups of the present invention. This property, as well as the stability of the cups, is enhanced by the primer material.

By using cellulose hydrate and a biodegradable primer material, the cups of the present invention are functional and versatile, but unlike conventional disposable cups, they are fully biodegradable or even compostable. In addition, the cups of the present invention may be partially or fully transparent.

In some embodiments, the cups of the present invention additionally comprise an insulating layer for heat storage. In one embodiment, this is a corrugated cardboard layer wrapped around the outside of the cup. In a preferred embodiment, the corrugated cardboard layer is made from recycled materials.

In some embodiments, the top edge of the cup may additionally be curled during the process to form a curled lip.

A cup of the present invention has a cellulose hydrate content ranging from 0.1% to nearly 100% (entire cup of cellulose hydrate, excluding the primer). In preferred embodiments, the cellulose hydrate content is 1% to 10%. In a particularly preferred embodiment of the invention, the cup is 94.9% paperboard/paper, 5% cellulose hydrate and 0.1% primer material. Exemplary compositions of the cup are shown in Table 2.

TABLE 2
Exemplary compositions of the cups

| Exemplary | Cellulose | | |
|---|---|---|---|
| cup | hydrate | Primer | Other Material |
| 1 | 95%-99.9% | 0.1%-5% | — |
| 2 | 98%-99.9% | 0.1%-2% | — |
| 3 | 2%-10% | 0.1%-5% | 85%-97.9% paper |
| 4 | 2%-10% | 0.1%-5% | 85%-97.9% cardboard |
| 5 | 2%-10% | 0.1%-5% | 85%-97.9% pulp fiber |
| 6 | 2%-10% | 0.1%-5% | 85%-97.9% pulp fiber |
| 7 | 2%-10% | 0.1%-5% | 5-20% pulp fiber |
| | | | 65%-92.9% starch |
| 8 | 2%-10% | 0.1%-5% | 5-20% pulp fiber |
| | | | 65%-92.8% starch |
| | | | 0.1%-0.5% preservatives |
| 9 | 5% | 0.1%-5% | 90%-94.9% paper |
| 10 | 5% | 0.1%-5% | 90%-94.9% cardboard |
| 11 | 5% | 0.1%-5% | 90%-94.9% pulp fiber |
| 12 | 5% | 0.1%-5% | 90%-94.9% pulp fiber |
| 13 | 5% | 0.1%-5% | 5-20% pulp |
| | | | 70%-89.9% starch |
| 14 | 5% | 0.1%-5% | 5-20% pulp |
| | | | 70%-89.8% starch |
| | | | 0.1%-0,5% preservatives |
| 15 | 5% | 0.1% | 94.5% paper |
| 16 | 10% | 0.1% | 89.5% paper |

Preferred volumes of the cups of the invention range from 25-2500 ml.

Cup—Variant 2

As an alternative to the previously described cups with at least one layer of cellulose hydrate and applied primer coating, the present invention also provides cups with a first layer of natural rubber or plant-based wax. The water impermeability and stability achieved in the above cups by cellulose hydrate and primer coating is achieved here by the natural rubber and plant-based wax, respectively.

All the above information about the shape, properties and manufacturing process of the cups (especially the bottom and the second layer of the sidewall, or even the admixture of magnesium stearate) can be transferred to these cups with the alternative first layers. The only difference is that instead of the first cellulose hydrate layer and the primer coating, the application of the alternative first layer of natural rubber or plant-based wax to the second layer of the sidewall is performed. The application of the first layer of natural rubber or plant-based wax is preferably done by spray nozzles, similar to the application of the primer material described above. Especially in the case of carnauba wax, the application of the first layer at a higher temperature (e.g. 70-120° C.) is favorable. The production of cups with the alternative first layers is shown below, as well as exemplified in Examples 9 and 10 and 14-16.

Properties of the Cups—Variant 2

Exemplary compositions of the cups without first layer of cellulose hydrate and primer are shown in Table 3.

TABLE 3
Exemplary compositions of the cups with an alternative first layer

| Exemplary | | |
|---|---|---|
| cup | Material of the first layer | Material of the second layer |
| 1 | natural rubber | paper |
| 2 | natural rubber | cardboard |
| 3 | natural rubber | cellulose |
| 4 | natural rubber | pulp fiber |
| 5 | natural rubber | 5%-35% cellulose 65%-95% starch |
| 6 | natural rubber | 3%-25% cellulose 74.5-95% starch |
| | | 0.1%-0.5% preservatives |
| 7 | natural rubber | 5-30% cellulose, 70-95% starch |
| 8 | natural rubber | 89% starch, 10% cellulose, |
| | | 1% magnesium stearate |
| 9 | natural rubber | 89% wheat starch, 10% cellulose, |
| | | 1% magnesium stearate |
| 10 | natural rubber | 89% corn starch, 10% cellulose, |
| | | 1% magnesium stearate |
| 11 | natural rubber | 84% starch, 10% cellulose, 5% wheat flour |
| | | 1% magnesium stearate |
| 12 | natural rubber | 84% wheat starch, 10% cellulose, 5% wheat |
| | | flour, 1% preservatives |
| 13 | natural rubber | 87.5% starch, 12% cellulose, 0.5% magnesium |
| | | stearate |
| 14 | natural rubber | 87.5% wheat starch, 12% cellulose, 0.5% |
| | | magnesium stearate |
| 15 | natural rubber | 87.5% corn starch, 12% cellulose, 0.5% |
| | | magnesium stearate |
| 16 | carnauba wax | paper |
| 17 | carnauba wax | cardboard |
| 18 | carnauba wax | cellulose |
| 19 | carnauba wax | pulp fiber |
| 20 | carnauba wax | 5-35% cellulose 65%-95% starch |
| 21 | carnauba wax | 3%-35% cellulose 74,5-95% starch |
| | | 0.1%-0.5% preservatives |
| 22 | carnauba wax, soy wax, canola | 5-30% cellulose, 70-95% starch |
| | wax or sunflower wax | |
| 23 | carnauba wax, soy wax, canola | 89% starch, 10% pulp, |
| | wax or sunflower wax | 1% magnesium stearate |
| 24 | carnauba wax, soy wax, canola | 89% wheat starch, 10% pulp, |
| | wax or sunflower wax | 1% magnesium stearate |
| 25 | carnauba wax, soy wax, canola | 89% corn starch, 10% pulp, |
| | wax or sunflower wax | 1% magnesium stearate |
| 26 | carnauba wax, soy wax, canola | 84% starch, 10% pulp, 5% wheat starch |
| | wax or sunflower wax | 1% magnesium stearate |
| 27 | carnauba wax, soy wax, canola | 84% wheat starch, 10% pulp, 5% wheat starch, |
| | wax or sunflower wax | 1% magnesium stearate |
| 28 | carnauba wax, soy wax, canola | 87.5% starch, 12% pulp, 0.5% magnesium |
| | wax or sunflower wax | stearate |
| 29 | carnauba wax, soy wax, canola | 87.5% wheat starch, 12% pulp, 0.5% |
| | wax or sunflower wax | magnesium stearate |
| 30 | carnauba wax, soy wax, canola | 87.5% corn starch, 12% pulp, 0.5% magnesium |
| | wax or sunflower wax | stearate |

Particularly preferred are the example cups comprising natural rubber and 89% starch, preferably wheat starch, 10% cellulose and 1% magnesium stearate.

Particularly preferred are the example cups comprising natural rubber and 89% starch, preferably cornstarch, 10% cellulose and 1% magnesium stearate.

Particularly preferred are the example cups comprising natural rubber and 85% starch, preferably wheat starch, 10% cellulose, 5% wheat flour and 1% magnesium stearate.

Particularly preferred are the example cups comprising carnauba, soy, canola or sunflower wax, preferably carnauba wax, and 89% starch, preferably wheat starch, 10% cellulose and 1% magnesium stearate.

Particularly preferred are the example cups comprising carnauba, soy, canola or sunflower wax, preferably carnauba wax, and 89% starch, preferably corn starch, 10% cellulose and 1% magnesium stearate.

Particularly preferred are the example cups comprising carnauba, soy, canola or sunflower wax, preferably carnauba wax, and 85% starch, preferably wheat starch, 10% cellulose, 5% wheat flour and 1% magnesium stearate.

Use of the Cups, Bowls and Containers

The present invention is exemplified with cups, bowls and containers, generally referred to as cups, and therefore the cups of the present invention are suitable for a variety of uses. They are suitable for a variety of beverages, such as hot beverages, tea, coffee, cold beverages, such as juice, juice spritzers, sodas, water, etc., or alcoholic beverages, such as beer, wine, cocktails, etc. In addition, the cups can also be used for other contents, preferably as containers for food, e.g. popcorn, ice cream or fruit, as transport containers for “to-go” dishes, soups, noodles, rice. The cups can also be used as plant pots. In the same way, the cups can be used as packaging material, e.g. in the form of a packaging box. The cups can also be used as paper buckets or other waste containers. The cups can also be used as storage containers.

Manufacturing Process

The present invention also provides methods of making cups in accordance with the present invention. Four alternative main variants exist: a method of manufacturing a cup having a first layer of primer-coated cellulose hydrate, wherein the bottom is manufactured separately and then bonded to the side wall; a method of manufacturing a cup having at least two layers, wherein a first layer is made of cellulose hydrate and is bonded to a second layer by coating with primer material, wherein the bottom is manufactured separately and then bonded to the side wall; a method for producing a cup with at least two layers, wherein a first layer consists of cellulose hydrate and is connected to a second layer by a coating with primer material, wherein in both layers the bottom and the side wall are produced in one piece, and a method for producing a cup with at least two layers, wherein a first layer consists of natural rubber or plant-based wax and a second layer consists of a mixture of cellulose hydrate, cardboard, fiber/cellulose and/or starch and the bottom is produced together with the cup.

Method of Manufacturing Cup Variant 1

Cup Variant 1

In the first embodiment, the method of the invention for producing cups comprises the following steps:
a. providing a first material for a first layer of the side wall of the cup,
   i. wherein the first material is cellulose hydrate,
b. coating the first material with a primer material,
c. cutting the first material coated with the primer material to size,
   i. shaping the cut first material to form the side wall of the cup, and bonding a bottom to the side wall of the cup.

Step a

In this step, cellulose hydrate is provided for the first layer of the sidewall. This is preferably done by providing a roll of cellulose hydrate film. In this case, the cellulose hydrate film has the properties described above for the first layer of the side wall of the cup.

Step b

In this step, the first layer of cellulose hydrate is coated with a primer material. Suitable primer materials are described above. In preferred embodiments, the coating is performed by spraying the first layer with the primer material. This can be done, for example, by slit-nozzle coating. In other embodiments, the coating was done by brushing or wetting the first layer with the primer material.

Step c

In this step, the primer material coated first layer is cut so that it has a suitable shape for the cup sidewall. This can be done, for example, by die cutting, such as with the Hangzhou Colon Machinery Co., Ltd. machine, model CL-DC850. In preferred embodiments, the cut material has the shape of a fan or a rectangle.

Step d

In this step, the cut material, e.g., fan-shaped material, is first formed into a sidewall. In some embodiments, the cut material is welded around a cylinder for this purpose. This can be done, for example, by the cup forming machine from SHANGHAI MENGJI INDUSTRIAL CO., LTD, model MJ-SL12. In other embodiments, the cut material is glued, sewn or stapled. Bonding may be done using a primer material.

Then the side wall is connected to a bottom. The bottom was previously made separately. It has the composition described above for the bottom. Preferably, the bottom is made by punching from a roll of a material. In some embodiments, the joining of the bottom and the sidewall is done by welding. This can be done, for example, by the cup-forming machine of SHANGHAI MENGJI INDUSTRIAL CO., LTD, model MJ-SL12. In other embodiments, this is done by gluing, sewing or stapling the bottom to the side wall.

Cup Variant 2

In the second embodiment, the method of the invention for producing cups comprises the following steps:
a. providing a second material for a second layer of the sidewall of the cup,
   i. wherein the second material comprises cellulose hydrate, paper, paperboard, pulp, fiber, starch, or a mixture thereof,
b. coating the second material with a primer material,
c. providing a first material for a first layer of the sidewall of the cup,
   i. wherein the first material is cellulose hydrate,
d. bonding the first material and the second material, at least in part by means of the primer material,
e. cutting the bonded first and second materials to size,
f. shaping the cut first and second materials to form the sidewall of the cup, and bonding a bottom to the sidewall of the cup.

Step a

In this step, the material for a second layer of the side wall is provided. This is preferably done by providing a roll of cardboard or paper. In this case, the second material film has a composition and properties described above for the material of the second layer of the side wall of the cup.

Step b

In this step, the second layer is coated with a primer material. Suitable primer materials are described above. In preferred embodiments, the coating is performed by spraying the second layer with the primer material. This can be done, for example, by slit-nozzle coating. In other embodiments, the coating was done by brushing or wetting the second layer with the primer material.

Step c

In this step, cellulose hydrate is provided for the first layer of the sidewall. This is preferably done by providing a roll of cellulose hydrate film. The cellulose hydrate film has the properties described above for the first layer of the side wall of the cup.

Step d

In this step, the second layer and the first layer are bonded together. This is done at least in part by the primer material applied to the second layer. This comes to lie between the first and second layers after bonding. In some embodiments, the second layer and the first layer are bonded by application of heat and/or pressure in addition to the adhesive force of the primer material. This can be accomplished using, for example, the ABGloss GmbH Grafische Maschinen CH-6330 Gloss Star 500S laminating machine. When bonding the two layers, a temperature of 80-200° C., preferably 100-150° C., more preferably 120° C. can be used. The pressure when joining the layers can be 1000-10,000 N/cm2, 2000-5000 N/cm2, more preferably 2500-4000 N/cm2. Suitable combinations are about 120° C. and 3000 N/cm2 or 100° C. and 5000 N/cm2.

Step e and f

Steps e and f of this variant correspond to steps c and d of the first variant, with the difference that instead of a first layer of cellulose hydrate coated with primer material, a composite material consisting of the first layer and the second layer, bonded by the primer material, is used.

Cup Variant 3

In the third embodiment, the method of the invention for producing cups comprises the following steps:
a. providing a second material for a second layer of the side wall of the cup and the bottom of the cup,
   i. wherein the second material comprises cellulose hydrate, paper, paperboard, pulp, fiber, starch, or a mixture thereof,
b. forming the second material to give it the shape of a cup comprising a sidewall and a bottom,
c. coating the second material with a primer material,
d. providing a first material for a first layer of the side wall of the cup and the bottom of the cup,
   i. wherein the first material is cellulose hydrate,
e. forming the first material to give it the shape of a cup comprising a sidewall and a bottom,
f. bonding the first and second materials together, at least in part by means of the primer material.

Step a

In this step, the material for a second layer of the side wall is provided. This is preferably done by providing a viscous mass. The second material film thereby has a composition and properties described above for the material of the second layer of the side wall of the cup. An exemplary composition is a mass of 1-50% (preferably 5-20%, more preferably 8%) cellulose, 50-97% (more preferably 70-95%, even more preferably 91.5%) starch and 0-1% (more preferably 0.5%) preservatives. The starch used is preferably potato starch or cornstarch. The composition may further comprise water.

Step b

In this step, the material for the second layer is formed into a sidewall and a bottom. In preferred embodiments, the sidewall and bottom are one piece.

In some embodiments, the forming is done by placing a mass into a compression mold. In this process, the compression mold may be heated to 100-300° C., more preferably to 200° C. It may also exert a pressure of 1000-10,000 N/cm2, more preferably 2000-5000 N/cm2, even more preferably 2500-4000 N/cm2. The pressing may happen for 5-250 s, more preferably 10-100 s, more preferably 30 s.

In some embodiments, molding is done by injecting a compound into an injection mold. In this case, the injection mold may be heated to 100-300° C., more preferably 200° C.

Exemplary methods for molding the second layer to form the sidewall and cup include hot pressing and injection molding. Any other molding process in which the mold is heated and water can escape can also be used.

Step c

In this step, the second layer to be cup-shaped from step b is coated with a primer material. Suitable primer materials are described above. In preferred embodiments, the coating is carried out by spraying the second layer with the primer material. This can be done, for example, by slot-nozzle coating. In other embodiments, the coating was done by brushing or wetting the second layer with the primer material.

Step d

In this step, cellulose hydrate is provided for the first layer of the sidewall. This is preferably done by providing a roll of cellulose hydrate film. In this step, the cellulose hydrate film has the properties described above for the first layer of the sidewall of the cup.

Step e

In this step, the material for the first layer is formed into a sidewall and a bottom. In preferred embodiments, the sidewall and bottom are a single piece.

In some embodiments, the forming is done by placing the first material into a compression mold. In this process, the compression mold may be heated to 80-300° C., more preferably to 100° C. It may also exert a pressure of 1000-10,000 N/cm2, more preferably 1500-5000 N/cm2, even more preferably 2000-3000 N/cm2. The pressing may happen for 1-60 s, more preferably 2-20 s, more preferably 5 s.

Step f

In this step, the cup-shaped second material coated with a primer material from step c and the first material from step e are bonded. This is done at least partially by the primer material applied to the second layer. Preferably, the first material is placed inside the second material for bonding the materials. In some embodiments, in addition to the adhesive force of the primer material, the second layer and the first layer are bonded by application of heat and/or pressure. This may be done, for example, using a pressing machine. A temperature of 80-200° C., preferably 90-150° C., more preferably 100° C., may be used in joining the two layers. The pressure used in joining the layers can be 1000-10,000 N/cm2, 2000-5000 N/cm2, more preferably 3000-4000 N/cm2. Pressing can happen for 1-60 s, more preferably 5-30 s, more preferably 15 s. The pressure and heat causes the shape of the first material to conform to the shape of the second material.

In some of these three embodiments, a viewing window is provided in the second layer of the side wall of the cup. This may be useful when the second layer of the cup is non-transparent (e.g., made of paperboard). The viewing window can be attached by punching in the second layer. The application of the viewing window can take place before or after the application of the primer material. Any suitable cutting and punching process known to those skilled in the art can be used to apply the viewing window. For example, a punching machine from Hangzhou Colon Machinery Co., Ltd. model CL-DC850 can be used.

Method of Manufacturing a Cup of Variant 2

In this variation, the method of the invention for producing alternative cups (Variation 2) consists of the following steps:
a. providing a second material for a second layer of the side wall of the cup and the bottom of the cup,
   i. wherein the second material comprises cellulose hydrate, paper, paperboard, pulp, fiber, starch, or a mixture thereof,
b. forming the second material to give it the shape of a cup comprising a sidewall and a bottom,
c. curing the second material,
d. providing a first material for a first layer of the side wall of the cup and the bottom of the cup,
   i. wherein the first material is natural rubber or plant-based wax, preferably carnauba wax,
e. coating the second material with the first material.

Step a

In this step, the material for a second layer of the side wall is provided. This is preferably done by providing a viscous mass. The second material thereby has a composition and properties described above for the material of the second layer of the side wall of the cup. An exemplary composition is a mass of 1-50% (preferably 5-20%, more preferably 8%) cellulose, 50-97% (more preferably 70-95%, even more preferably 91.5%) starch and 1% magnesium stearate. The starch used is preferably wheat starch. The composition may additionally comprise water.

Step b

In this step, the material for the second layer is formed into a sidewall and a bottom. The sidewall and bottom are preferably in one piece.

In some embodiments, forming is done by placing a mass into a compression mold. In this process, the press mold may be heated to 100-300° C., more preferably to 200° C. It may also exert a pressure of 1000-10,000 N/cm2, more preferably 2000-5000 N/cm2, even more preferably 2500-4000 N/cm2. The pressing may happen for 5-250 s, more preferably 10-100 s, more preferably 30 s.

In some embodiments, molding is done by injecting a compound into an injection mold. In this case, the injection mold may be heated to 100-300° C., more preferably 200° C.

Exemplary methods for molding the second layer to form the sidewall and cup include hot pressing and injection molding. Any other molding process in which the mold is heated and water can escape can also be used.

Step c

In this step, the cup formed in step b) is cured.

Step d

In this step, plant-based wax or natural rubber is provided for the first layer of the sidewall. The wax or natural rubber has the properties described above for the first layer of the side wall of the cup.

Step e

In this step, the second layer is coated with the first layer. In preferred embodiments, the coating is done by spraying the second layer with the material of the first layer. This can be done, for example, by slit-nozzle coating. In other embodiments, the coating was done by brushing or wetting the second layer with the material of the first layer. In some embodiments, the coating is done by using a centrifuge.

Further Process Steps

All four variants of the method may comprise further steps in some embodiments.

Exemplary further steps are listed below.

In some embodiments, particularly the first and second variants, an additional step of curling the top edge of the cup to form a curling lip is performed after the last step described above.

In some embodiments, the side wall of the cup is printed. This can be done in the first embodiment by printing the first cellulose hydrate layer. In the second, third and fourth embodiments, the second layer is preferably printed. In the methods in which a primer material is applied, the printing may take place before or after the application of the primer material. For printing, all suitable printing processes known to the skilled person can be used, for example flexographic printing processes or laser printing processes. For example, a printing machine from Guowei, GWR, or Hangzhou Colon Machinery Co, Ltd, model CL-DC850, can be used. Preferably, the printing is done with non-toxic inks. In particularly preferred embodiments, food coloring is used for printing.

In other embodiments, instead of printing the cup, a logo or lettering is “baked in” during the manufacture of the cup. In the case of press molding or casting processes, this is done using a press mold/mold that imprints the logo/lettering. This can eliminate the need for printing. This can save costs and be environmentally friendly due to the lower consumption of ink.

Lids

Cups, bowls and containers often have lids to prevent spillage of the liquid or contents. Therefore, the present invention also provides lids for cups, bowls and containers.

Material

A lid of the present invention comprises the material described above for the side wall of the cup. Thus, the lid of the present invention comprises a first layer comprising cellulose hydrate, the first layer being coated with a primer material. All other embodiments described under “b) Side wall” can also be applied to the material of the lid.

As an alternative to cellulose hydrate with primer coating, the lid of the present invention comprises a first layer comprising natural rubber or plant-based wax and a second layer comprising cellulose hydrate, paper, cardboard, pulp, fiber, starch or a mixture thereof. Again, the embodiments described above for the sidewall of the alternative cup can be implemented in this embodiment.

As described above for cellulose hydrate with primer coating as well as for the alternative first layer, in some embodiments the lid of the present invention further comprises magnesium stearate.

In preferred embodiments, the lid is compostable and/or fully biodegradable.

Combination of Cup and Lid

The cup and lid of the present invention may be formed in combination. Thus, the present invention also includes a combination of cup and lid formed from a cup of the present invention and a lid of the present invention. Preferably, in this case, the side wall of the cup and the lid are made of the same material.

In some embodiments, the lid and the cup may be connected by a screw system. Here, the cup may be the “screw” and the lid the “nut”, or vice versa. For this purpose, protrusions and indentations are inserted into the cup and lid to form a thread. The insertion of the thread's protrusions and indentations may occur during the manufacture of the cup and lid, or at a later time.

In other embodiments, a “click system” is used in which a protrusion of the lid engages a notch of the cup, or vice versa. The insertion of the protrusions and indentations may occur during the manufacture of the cup and lid, or at a later time.

In particularly preferred embodiments, screw system or click system are used for cups and lids with a first layer of natural rubber. Natural rubber leads to increased resistance in the screw system or click system, which enables better sealing of the cup.

Exemplary lids of the cups of the present invention comprise a first wax layer or rubber layer applied with spray cans or in a dip tank and a second layer of cellulose and/or starch and optionally magnesium stearate.

Manufacturing Method for Lids and Cups and Lids

A lid of the present invention can be manufactured according to the methods described above for cups, except that a lid-shaped mold is formed rather than a cup-shaped mold.

The invention also provides a method of making a combination cup and lid. In this case, the cup is made according to a method described above. In some embodiments, the lid is made by the same process as the cup. In preferred embodiments, the cup and lid are manufactured by a compression molding or casting process (see, e.g., Examples 12-16). In particularly preferred embodiments, the cup and lid are made by a compression molding or casting process and comprise magnesium stearate

### EXAMPLES

The present invention is described in detail by the following non-limiting examples.

### Example 1: Production of a Transparent Cellophane (Cellulose Hydrate) Cup with Primer Coating

A commercially available cellophane film with a thickness of 1 mm and a width of 86 cm was used to produce the cup.

A roll of this cellophane film was loaded into a printing machine from Guowei, GWR. Flexographic printing was used to print the design for the sidewall onto the cellophane film. Then a heat-responsive primer was applied to the roll of cellophane as a wet film. This was done by slit-nozzle coating, via a casting head with a distribution chamber.

Then, the printed and primer-coated cellophane film was placed in a die-cutting machine from Hangzhou Colon Machinery Co, Ltd, model CL-DC850. Compartments for the side wall of the cup were die-cut from the film.

In the next step, the die-cut compartments and a 15 cm wide cellophane roll were placed in the magazines of a cup forming machine from SHANGHAI MENGJI INDUSTRIAL CO., LTD, model MJ-SL12. This machine wrapped the die-cut cellophane fan around a metallic cylinder and then welded it by heating metallic troughs to form the side wall of the cup. At the same time, the circular cup base was punched from the cellophane roll. The cup bottom was now joined to the side wall by means of the heated metallic troughs. Finally, the top edge of the cup was rolled to form a curly lip.

The finished cups had a volume of 500 ml. They were stacked and packaged according to hygiene regulations.

### Example 2: Production of a Paper Cup with Cellophane Coating

A roll of paper was used to make the cup. The paper had a thickness of 220 g/m2 and a width of 86 cm.

The roll of paper was inserted into the printing machine of Guowei, GWR. Through laser printing process, the design for the side wall was printed on the paper.

Then, the printed roll of paper and a cellophane roll with a thickness of 23 μm were loaded into the ABGloss GmbH Grafische Maschinen CH-6330 Gloss Star 500S laminating machine. In the following process, the paper and cellophane were bonded with a primer. For this purpose, a primer that reacts to heat was applied to the paper as a wet film. This was done by means of slot die coating, via a casting head with distribution chamber. The primer-coated paper and the cellophane film were then brought together and pressed by two heated metallic cylinders at 120 C° with a pressure of 3000 N/cm2.

The primer used was a vegan, acid-free, crystal clear adhesive without solvent. It consisted of gum arabic, potato starch (from controlled organic cultivation, kbA*) and water.

Then, the composite material of paper and cellophane was placed in a die-cutting machine from Hangzhou Colon Machinery Co, Ltd, model CL-DC850. The material was used to die-cut compartments for the side wall of the cup.

In the next step, the die-cut compartments and a 15 cm wide cellophane-coated cardboard roll were placed in the magazines of a cup-forming machine from SHANGHAI MENGJI INDUSTRIAL CO., LTD, model MJ-SL12. This machine wrapped the die-cut fan around a metallic cylinder and then welded it by heating metallic troughs to 120° C. to form the side wall of the cup. At the same time, the circular cup base was punched from the cellophane-coated cardboard roll. The cup bottom was now joined to the side wall using the heated metallic troughs (120° C.). Finally, the top edge of the cup was rolled to form a curly lip.

The finished cups were stacked and packaged according to hygiene regulations.

### Example 3: Production of a Paper Cup with Cellophane Coating with a Viewing Window

A roll of paper was used to make the cup. The paper had a thickness of 160 g/m2 and a width of 86 cm.

The roll of paper was inserted into the printing machine of Guowei, GWR. Through flexographic printing process, the design for the side wall was printed on the paper.

Then, the printed cardboard roll was loaded into a die-cutting machine of Hangzhou Colon Machinery Co, Ltd, model CL-DC850, and a viewing window with 1.5 cm width and 5 cm length was die-cut.

Then, the paper was sprayed with a primer (vegan adhesive made of gum arabic, potato starch and water) as described in Example 2 and bonded with a cellophane film. Further production of the cup was also carried out as in Example 2.

### Example 4: Production of a Paper Cup with Cellophane Coating and Three Viewing Windows

A roll of paper was used to make the cup. The paper had a thickness of 180 g/m2 and a width of 86 cm.

The roll of paper was inserted into the printing machine of Guowei, GWR. Through flexographic printing process, the design for the side wall was printed on the paper.

Then, the printed cardboard roll was loaded into a die-cutting machine of Hangzhou Colon Machinery Co, Ltd, model CL-DC850, which punched out three circular viewing windows with a diameter of 3 cm.

Then, the paper was sprayed with a primer (vegan adhesive made of gum arabic, potato starch and water) as described in Example 2 and bonded with a cellophane film. Further production of the cup was also carried out as in Example 2.

### Example 5: Production of Paper Cups from Wood Pulp with Cellophane Coating with a Viewing Window

A roll of paper made of wood pulp was used to produce the cup. The paper had a thickness of 160 g/m2 and a width of 86 cm.

The roll of paper was inserted into the printing machine of Guowei, GWR. Flexographic printing process was used to print the design for the sidewall on the paper.

Then, the printed cardboard roll was inserted into a die-cutting machine of Hangzhou Colon Machinery Co, Ltd, model CL-DC850, and a viewing window with 1 cm width and 6 cm length was die-cut.

Then, the paper made of wood pulp was sprayed with a primer (vegan adhesive made of gum arabic, potato starch and water) as described in Example 2 and bonded with a cellophane film. Further production of the cup was also carried out as in Example 2.

### Example 6: Production of a Transparent Double-Layer Cellophane Cup

A commercially available cellophane film with a thickness of 1 mm and a width of 86 cm was used to produce the cup.

A roll of this cellophane film was inserted into a printing machine from Guowei, GWR. Through flexographic printing process, the design for the side wall was printed on the cellophane film.

Then, the printed cellophane roll and another cellophane roll with a thickness of 23 μm were loaded into the ABGloss GmbH Grafische Maschinen CH-6330 Gloss Star 500S laminating machine. In the following process, the two cellophane films were joined with a primer. The primer used was either a combination of gum arabic, potato starch and water or gum arabic, cornstarch and water. The primer was applied as a wet film to the printed cellophane film. This was done by slot die coating, via a casting head with distribution chamber. The primer-coated cellophane film and the other cellophane film were then brought together and pressed.

Then, the composite material of the two cellophane films was placed in a die-cutting machine of Hangzhou Colon Machinery Co, Ltd, model CL-DC850. The material was used to die-cut compartments for the side wall of the cup.

In the next step, the die-cut compartments and a 15 cm wide cellophane roll, which consisted of two layers of cellophane bonded with the primer, were placed in the magazines of a cup forming machine from SHANGHAI MENGJI INDUSTRIAL CO., LTD, model MJ-SL12. This machine wrapped the punched fan around a metallic cylinder and then welded it by heating metallic troughs to 120° C. to form the side wall of the cup. At the same time, the circular cup base was punched from the 15 cm wide cellophane roll. The cup bottom was now joined to the side wall by means of the heated metallic troughs (120° C.). Finally, the top edge of the cup was rolled to form a curly lip.

The finished cups had a volume of 350 ml. They were stacked and packaged according to hygiene regulations.

### Example 7: Production of a Cup with Plant Starch Content with Cellophane Coating Using the Hot Press Process

Here, the cup made of one of cellulose and plant-based starch was used. To produce the cup, 8% cellulose, 91.5% potato starch and 0.5% preservatives were added to a kneading machine, model Spiral Kneader KM 120T. The total dry mass had a weight of 40 kilograms. In addition, 24 liters of water were added, thus a total weight of 64 kilograms was obtained. The machine kneaded the mixture to a homogeneous mass in 20 minutes. The mass was then separated into spherical 25-gram portions by means of metering spoons. The portions of the mass were then placed on a conveyor belt, which conveyed them into the cavities of a press mold heated to 200° C. The mold was closed with a pressure plate. The compression mold closed with a pressure of 3500 N/cm2 for 30 seconds. As a result of the pressure, the mass acquired the cup shape specified by the press mold. Here, the high temperature served the curing process of the mass, the water part of the mass escaped in gas form. After the pressing process, the formed cup was removed from the mold.

The cup was then placed in a hydraulic punching press, which was actuated by operating the pressure piston. A vertical viewing window was punched out of the upper part of the cup. This was located 0.5 cm below the lip and was 2 cm wide and 8 cm long.

The cup was then placed in a pad printing machine (SCDEL TIC 301) and printed with a logo.

After that, the cup was sprayed with a primer made of gum arabic, tapioca starch and water using spray nozzles. Simultaneously, a cut cellophane film (1.2 mm thickness) was placed in a molding press and pressed at a pressure of 2000 N/cm2 for 5 seconds. This cellophane film, preformed by pressing, was then removed and placed in the pulp/starch cup prepared beforehand. The cup and cellophane film were placed in a cavity of a pressing machine heated to 100° C. The compression mold closed with a pressure of 3500 N/cm2 and compressed the cup and preformed cellophane film for 15 seconds. At this time, the primer sprayed beforehand bonded the cup and the preformed cellophane film together. The cellophane conformed to the inner wall of the pulp/starch cup by the action of pressure and heat.

The finished cups were stacked and packaged according to sanitary regulations.

### Example 8: Production of a Cup with Plant Starch Content with Cellophane Coating by Injection Molding

Here, the cup made of a mass of cellulose and plant-based starch was used, which was molded into the shape of a cup. To produce the mass, 12% cellulose, 87.5% cornstarch and 0.5% preservatives were added to a kneading machine, model Kemper ST 125 AE. The total dry mass had a weight of 30 kilograms. In addition, 20 liters of water were added, thus a total weight of 50 kilograms was obtained. The machine kneaded the mixture to a homogeneous mass in 25 minutes. The mass was then pumped into a tank standing on rollers. The tank was connected to a modified injection molding machine with a hose.

The homogeneous mass was then poured into a downward-tapered injection unit that contained a rotating screw and a nozzle at the tip. The mass was conveyed toward the nozzle by rotating the screw. The mass collected in front of the closed nozzle. Since the screw was axially movable, it evaded the pressure building up in front of the nozzle and unscrewed from the mass in a manner similar to a corkscrew. The backward movement of the screw was electrically braked, so that a dynamic pressure built up in the mass. This dynamic pressure in conjunction with the screw rotation compacted the mass. The screw position was measured continuously, and as soon as a sufficient amount of material had accumulated in the mass for the bucket volume, the metering process was completed and the screw rotation was stopped. Likewise, the screw was actively or passively unloaded so that the compound was decompressed. In the injection phase that now followed, the injection unit was moved to the clamping unit of a cup-shaped injection mold, the nozzle was pressed against the injection mold and the screw was pressurized at the rear. As a result, the compound was forced under high pressure (1500 bar) through the opened nozzle and the sprue system of the injection mold into the molding cavity (heated to 200° C.) of the injection mold. A non-return valve prevented the compound from flowing back toward the injection unit. As a result of the heating of the compound in the cavity, the water content escaped in gaseous form through the holes provided for this purpose in the injection mold. During injection, an attempt was made to achieve the most laminar possible flow behavior of the compound, i.e. the compound was immediately heated in the injection mold where it touched the heated wall of the mold and thus solidified. The newly injected compound was forced through the injection channel at high speed. This high injection velocity created a shear rate in the compound, which allowed the compound to flow more easily. Fine tuning of the injection phase allowed the structure of the surface and the appearance of the cup to be influenced. After injection, the nozzle was closed and the metering process for the next cup could begin in the injection unit. The material in the injection mold continued to cool until the core, the liquid core of the cup, had also hardened and reached the final cup shape. To demold, the ejector side of the injection mold was opened and the pulp/starch cup was ejected by pins penetrating the cavity. One molding cycle lasted 25 seconds.

Then the pulp/starch cup was placed in a hydraulic punch press, which was actuated by operating the plunger. A vertical viewing window was punched in the upper part of the cup. This was located 0.8 cm below the lip and was 2.5 cm wide and 6 cm long.

The cup was then placed in a pad printing machine (SCDEL TIC 301) and printed with a logo.

After that, the cup was sprayed with a primer made of gum arabic, potato starch and water using spray nozzles. At the same time, a cut-to-size cellophane film (1.2 mm thickness) was placed in a molding press and compressed at a pressure of 2000 N/cm2 for 5 seconds. This cellophane film, preformed by pressing, was then removed and placed in the pulp/starch cup prepared beforehand. The cup and cellophane film were placed in a cavity of a pressing machine heated to 100° C. The compression mold closed with a pressure of 3500 N/cm2 and compressed the cup and preformed cellophane film for 15 seconds. At this time, the primer sprayed beforehand bonded the cup and the preformed cellophane film together. The cellophane conformed to the inner wall of the pulp/starch cup by the action of pressure and heat.

The finished cups were stacked and packaged according to sanitary regulations.

In other test trials, the cornstarch in the pulp to produce the pulp/starch cup was replaced by potato starch or a combination of cornstarch and potato starch. The further process was unchanged.

### Example 9: Production of a Cup with Plant-Based Starch Content with Natural Rubber Layer by the Hot Press Process

The casting of a cup made from 9% cellulose, 90.5% potato starch and 0.5% preservatives was carried out by the hot-press process as described in Example 7. However, no viewing window was punched into the cup at the end of the casting process.

The cup was then placed in a pad printing machine (SCDEL TIC 301) and printed with a logo.

The cup was then sprayed with a pre-vulcanized natural latex milk using spray nozzles. The latex milk had an ammonia content of 0.3%.

The cup was then air-dried over a period of 12 hours.

The finished cups were stacked and packaged according to hygienic regulations.

### Example 10: Production of a Cup with Plant Starch Content with Carnauba Wax Layer by Injection Molding

The molding of a cup made of 12% pulp, 87.5% cornstarch and 0.5% preservatives was carried out by the injection molding process as described in Example 8. However, no viewing window was punched into the cup at the end of the casting.

The cup was then placed in a pad printing machine (SCDEL TIC 301) and printed with a logo.

The cup was then sprayed with carnauba wax using heated (90 C°) spray nozzles.

The cup was air dried within a period of 6 hours.

The finished cups were stacked and packed according to hygienic regulations.

### Example 11: Production of a Cup with Plant Starch Content with Carnauba Wax Layer Using the Injection Molding Process with Magnesium Stearate

The casting of a cup made of 8% cellulose, 86.5% cornstarch, 5% magnesium stearate and 0.5% preservatives was carried out by the injection molding process as described in Example 8. The use of the magnesium stearate made the cast cup easier to release from the mold than in Example 10. At the end of casting, no viewing window was punched into the cup.

The cup was then placed in a pad printing machine (SCDEL TIC 301) and printed with a logo.

The cup was then sprayed with carnauba wax using heated (90 C°) spray nozzles.

The cup was air dried within a period of 6 hours.

The finished cups were stacked and packed according to hygienic regulations.

### Example 12: Production of a Lid and Cup with Screw Cap with Plant Starch Content with Cellophane Coating Using the Hot Press Process

Here, a lid and a cup were produced from cellulose and plant-based starch. A homogeneous mass was prepared as described in Example 7. The mass was then separated into a spherical 25-gram portion for the cup and 9-gram portion for the lid using a metering spoon. The portions of the mass were then placed on a conveyor belt, which conveyed them into the cavities of a compression mold heated to 200° C. The compression mold closed with a pressure of 3500 N/cm2 for 30 seconds. As a result of the pressure, the mass acquired the cup shape and lid shape specified by the compression mold. Here, the high temperature served the curing process of the mass, and the water portion of the mass escaped in gas form from the outlet valve. Due to the shape of the mold, a screw system was “baked” into the lid and cup. After the pressing process, the molded cup and lid were removed from the mold.

Then the cup and lid were sprayed with a pre-vulcanized natural latex milk using spray nozzles. The latex milk had an ammonia content of 0.3%.

The cups and lids were then dried in air over a period of 12 hours.

The finished lids and cups were stacked and packaged according to hygiene regulations.

### Example 13: Production of a Lid and Cup with “Click System” and “Baked-In” Logo and Lettering with Plant Starch Content with Cellophane Coating Using the Injection Molding Process

Here, the lid and cup were made from a mass of cellulose and plant starch. The compound was produced as described in Example 8. The casting was also carried out as described in Example 8, with the difference that a lid was also cast in addition to the cup. Due to the shape of the mold, a “click system” and a logo were “baked” into the lid and cup. One casting cycle lasted 25 seconds.

Then the cup and lid were sprayed with a pre-vulcanized natural latex milk using spray nozzles. The latex milk had an ammonia content of 0.3%.

The cups and lids were then dried in air over a period of 12 hours.

The finished lids and cups were stacked and packaged according to hygiene regulations.

### Example 14: Production of a Cup Using the Hot Press Method

Here, the cup was made of material from cellulose and plant-based starch, which was pressed into the shape of a cup. To produce the material, 5.9% pulp, 52.4% corn starch, 0.6% magnesium stearate and 41.1% water (at 40° C.) were added to a mixer (corresponding to a product composition of 89% corn starch, 10% pulp, 1% magnesium stearate). First, pulp was added to water to prevent subsequent clumping of pulp in the compound. The machine mixed the mixture to a homogeneous mass in 20 minutes. The mass was then pressed into an elongated mold using a “single screwdriver” and portioned into 15-gram portions. The portions of the mass were then transferred to a conveyor belt, which conveyed them into the cavities of the cup-press mold, which were heated to 240° C. The cup-press mold gave each portion its own shape. The press mold gave cup shape to each portion of the mass. After the pressing process, the formed cup was lifted out of the mold by means of vacuum suction cups, so that no forced demolding was necessary, which would cause the material to break.

The cups were then lifted onto the conveyor belt, which carried the cups to the coating machine. The cups were placed in the centrifuges. The wax for coating entered the cups through spray nozzles. The coaters were finally coated with the applied wax by centrifugation. Excess wax was collected for further use. The cups were then placed on the drying and UV tunnels simultaneously using gripper arms. The coating was dried slowly so that no cracks could appear in the surface structure. This process was carried out one third of the time at 70° C. and two thirds of the time at 40° C. and 30° C., and continuous UV irradiation.

The cup was then placed in a pad printing machine (SCDEL TIC 301) and printed with a logo.

The finished cups were stacked and packaged according to hygiene regulations.

### Example 15: Production of a Cup Using the Injection Molding Process

Here, the cups were made from a material of cellulose and plant-based starch, which was molded into the shape of a cup. To produce the material, 7% pulp, 51.5% cornstarch, 0.3% magnesium stearate and 41.1% water were added to a mixer (corresponding to a product composition of 87.5% cornstarch, 12% pulp and 0.5% magnesium stearate). First, water was added to pulp to prevent subsequent clumping of pulp in the compound. The machine mixed the components of the material into a homogeneous mass in 15 minutes. The mass was then pumped into a tank. The tank was connected to a modified injection-molding machine with a hose.

The homogeneous mass was poured into a downward-tapering injection unit that contained a rotating screw and a nozzle at the tip. The mass was conveyed toward the nozzle by rotating the screw. The mass collected in front of the closed nozzle. Since the screw was axially movable, it evaded the pressure building up in front of the nozzle and unscrewed from the mass in a manner similar to a corkscrew. The backward movement of the screw was electrically braked, so that a dynamic pressure built up in the mass. This dynamic pressure, in conjunction with the screw rotation, compacted the mass. The mass was decompressed by active or passive unloading of the screw. In the following process, the compound was pressed under high pressure (1500 bar) through the open nozzle and the sprue system of the injection mold into the molding cavity (heated to 200° C.) of the injection mold. A non-return valve prevented the compound from flowing back toward the injection unit. Heating the compound in the cavity allowed the water content to escape in gaseous form. During injection, an attempt was made to achieve the most laminar possible flow behavior of the compound, i.e. the compound was immediately heated in the injection mold where it touched the heated wall of the mold and thus solidified. The high injection speed created a shear rate in the compound, which made it flow more easily. Fine tuning of the injection phase allowed the structure of the surface and the appearance of the cup to be influenced. After injection, the nozzle was closed and the metering process for the next cup could begin in the injection unit. The material in the injection mold continued to cool until the core, the liquid core of the cup, had also hardened and the final cup shape had been achieved. The cup was then ejected. One casting cycle lasted 45 seconds.

The cup was then placed in a pad printing machine (SCDEL TIC 301) and printed with a logo.

A conveyor belt carried the cups to spray nozzles, which sprayed them with a coating of gum arabic, potato starch and wax.

In a drying and UV tunnel, the cups and the coating were allowed to dry slowly so that no cracks appeared in the surface structure. This process was carried out one-third of the time at 75° C. and two-thirds of the time at 40° C. and 20° C., and continuous UV irradiation.

The finished cups were stacked and packaged according to hygiene regulations.

### Example 16: Production of a Lid with a Wax Coating Using the Hot-Pressing Method

Lids were made from a material of cellulose and plant-based starch, which was pressed into the shape of a lid. To produce the material, 5.9% pulp, 52.4% wheat starch, 0.6% magnesium stearate and 41.1% water (50° C.) were added to a mixer (corresponding to a product composition of 89% wheat starch, 10% pulp and 1% magnesium stearate). First, pulp was added to water to prevent subsequent clumping of pulp in the mixture. The machine mixed the mixture to a homogeneous mass in 20 minutes. The mass was then pressed into an elongated mold using a “single screwdriver” and portioned into 8-gram portions. The portions of the mass were then conveyed onto a conveyor belt, which transported them into the cavities of the lid-pressing mold heated to 240° C. The mass was then pressed into the mold using a single screwdriver. The pressure gave the mass the lid shape specified by the compression mold. The high temperature was used to cure the compound, and the water content of the compound escaped in the form of gas. After the pressing process, the formed lid was lifted out of the mold by means of vacuum suction buttons, so that no forced demolding was necessary, which would cause the produced material to break.

Conveyor belts carried the lids to spray nozzles, which sprayed them with wax. The wax coated the lids by centrifugation. Excess wax was returned for further use. The lids were then conveyed through the drying and UV tunnel. Here, the coating dried slowly so that no cracks appeared in the surface structure. This process was carried out one third of the time at 70° C. and two thirds of the time at 40° C. and 30° C., and continuous UV irradiation.

The finished lids were stacked and packaged according to hygiene regulations.

1.-41. (canceled)

42. A cup comprising:
a bottom (1) and
a side wall (2) comprising:
a first layer (5) consisting of cellulose hydrate, and
a second layer (3) comprising cellulose hydrate, paper, cardboard, pulp, fiber, starch or a mixture thereof,
wherein the side wall (2) of the cup is impermeable to water,
wherein the cup consists essentially of plant-based material.

43. The cup according to claim 42, wherein the cup is compostable and/or fully biodegradable.

44. The cup according to claim 42, wherein the first layer (5) corresponds to an inner layer of the cup and the second layer (3) corresponds to an outer layer of the cup.

45. The cup according to claim 42, wherein the first layer (5) is coated with a primer material (4), and wherein the first layer (5) and the second layer (3) are bonded together by the primer material (4).

46. The cup according to claim 45, wherein the primer material (4) comprises arabic gum, potato starch, cornstarch or tapioca starch, or starch derived from cassava, tuberous bean, batata, yam, tuberous pea, arakacha, tuberous wood sorrel, tuberous nasturtium, ulluco, East Indian arrowroot, arrowroot, achira, taro, tannia, white water lily, yellow pond rose, or chayote.

47. The cup according to claim 45, wherein the primer material (4) comprises arabic gum and starch, wherein the starch is potato starch or cornstarch.

48. The cup according to claim 42, wherein the second layer (3) comprises pulp and/or fiber.

49. The cup according to claim 42, wherein the second layer (3) comprises baobab plant material.

50. The cup according to claim 42, wherein the second layer (3) further comprises magnesium stearate.

51. The cup according to claim 42, wherein the bottom (1) comprises cellulose hydrate.

52. The cup according to claim 42, wherein the cup comprises at east one viewing window (6).

53. The cup according to claim 42, wherein the cup is completely transparent.

54. A method of manufacturing the cup according to claim 42, comprising:
providing a first material for a first layer (5) of the side wall (2) of the cup and the bottom (1) of the cup, wherein the first material consists of cellulose hydrate;
providing a second material for a second layer (3) of the side wall (2) of the cup and the bottom (1) of the cup, wherein the second material comprises cellulose hydrate, paper, cardboard, pulp, fiber, starch or a mixture thereof;
forming the second material to shape a cup comprising the side wall (2) and the bottom (1);
coating the second material with a primer material (4);
forming the first material to of a cup comprising the side (2) wall and a bottom (1); and
bonding the first material and the second material using the primer material (4).

55. The method according to claim 54, further comprising:
punching a viewing window (6) in the second material and/or
printing the first material and/or the second material.

56. A cup comprising:
a bottom (1), and
a side wall (2),
wherein the sidewall (2) comprises a first layer (5) and a second layer (3),
wherein the first layer (5) consists of natural rubber or plant-based wax,
wherein the second layer (3) comprises a mixture of pulp and/or fiber and starch, and
wherein the cup consists essentially of plant-based materials.

57. The cup according to claim 56, wherein the second layer (3) additionally comprises magnesium stearate.

58. A lid for use in combination with a cup,
wherein the lid consists of a first layer comprising cellulose hydrate or a first layer comprising natural rubber or plant-based wax and,
wherein the lid consists of a second layer comprising paper, paperboard, pulp, fiber, starch, or a mixture thereof,
wherein the lid consists essentially of plant-based material.

59. The lid according to claim 58, wherein the lid is compostable and/or fully biodegradable.

60. The lid according to claim 58, wherein the lid comprises magnesium stearate.

61. A method of manufacturing a cup comprising a bottom (1) and a side wall (2), comprising:
providing a first material for a first layer of the side wall (2) of the cup and the bottom (1) of the cup, wherein the first material comprises natural rubber or plant-based wax;
providing a second material for a second layer (3) of the side wall (2) of the cup and the bottom (1) of the cup wherein the second material comprises a mixture of pulp and/or fiber and starch and additionally water;
forming the second material to shape a cup comprising the side wall (2) and the bottom (1);
curing the second material; and
coating the second layer (3) of the side wall (2) of the cup and the bottom (1) of the cup of the second material with the first material, thereby producing the first layer (5) of the side wall (2) of the cup and the bottom (1) of the cup.
